(19) United States
(12) Patent Application Publication
(10) Pub. No.: US 2015/0269538 A1
(43) Pub. Date: Sep. 24, 2015

(54) SECURITY DEVICES AND SYSTEMS FOR DIGITAL CURRENCY TRANSFER

(71) Applicant: Darin Stanchfield, Bothel, WA (US)

(72) Inventor: Darin Stanchfield, Bothel, WA (US)

(21) Appl. No.: 14/217,803

(22) Filed: Mar. 18, 2014

(51) Int. Cl. G06Q 20/06; G06Q 20/38

(52) U.S. Cl. CPC G06Q 20/065; G06Q 20/3829; G06Q 2220/00

(57) ABSTRACT

Digital currency transfer security systems including a digital network, a first device configured to store and transfer digital currency, and a second device configured to provide a security measure during transfer of digital currency from the first device are described. The first device is configured to provide a first public key and provide a first private key signature, the first public key being accessible via the first private key signature. The second device is configured to provide a second public key and provide a second private key signature, the second public key being accessible via the second private key signature. Providing the first public key from the first device and the second public key from the second device generates a multisignature public key capable of storing and transferring digital currency, the multisignature public key being accessible for transfer of digital currency via the first private key signature and the second private key signature.

### BACKGROUND

The present disclosure relates generally to security devices and systems for digital currency transfer. In particular, security devices and systems that utilize multisignature public keys accessed via a first private key signature provided by a first device and a second private key signature provided by a second device for digital currency transfer are described.

Known digital currency transfer systems, devices, and methods are not entirely satisfactory for the range of applications in which they are employed. For example, existing digital currency transfer systems, devices, and methods require a private key and/or a private key signature to unlock and/or access a public key to permit digital currency transfer (i.e., public/private key cryptography). Although the public key is only accessible via the private key and/or the private key signature, there is a risk that a user's device (e.g., a computer, a mobile device, etc.) where the private key is stored may be subject to unauthorized access by an unauthorized user.

In one specific example, the user's device may be subject to unauthorized access by direct physical access to the device. In another specific example, the user's device may be subject to unauthorized access by remote access to the device over a network. In both of these examples, the unauthorized user may then use the stolen private key and/or private key signature to carry out an unauthorized transfer digital currency. Because digital currency transfers are generally irreversible and anonymous, the original owner has no recourse to recover lost digital currency. Many occurrences of digital currency theft have been reported, including theft via malware specifically designed for digital currency theft, resulting in the loss of digital currency worth more than a billion U.S. dollars.

Thus, there exists a need for digital currency transfer security devices and systems that improve upon and advance the design of known methods of digital currency transfer. Examples of new and useful devices, systems, and methods relevant to the needs existing in the field are discussed below.

### SUMMARY

The present disclosure is directed to digital currency transfer security systems. In some examples, the digital currency transfer security system includes a digital network, a first device configured to store and transfer digital currency, and a second device configured to provide a security measure during transfer of digital currency from the first device. The first device has a first computer with a first processor, a first non-transitory computer-readable storage medium, the first non-transitory computer readable storage medium having a first set of computer-readable instructions for providing a first public key, and providing a first private key signature, the first public key being accessible via the first private key signature. The second device has a second computer with a second processor, a second non-transitory computer-readable storage medium, the second non-transitory computer-readable storage medium having a second set of computer-readable instructions for: providing a second public key, and providing a second private key signature, the second public key being accessible via the second private key signature. In some examples, providing the first public key from the first device and the second public key from the second device generates a multisignature public key capable of storing and transferring digital currency, the multisignature public key being accessible for transfer of digital currency via the first private key signature and the second private key signature.

### BRIEF DESCRIPTION OF THE DRAWINGS

FIG. 1 shows a schematic view of an example of a programmable computing device.

FIG. 2 shows a schematic view of an example of a mobile electronic device.

FIG. 3 is a schematic view of a first example of a digital currency transfer security device and system.

FIG. 4 is a schematic view of the first example of a digital currency transfer security device and system shown in FIG. 3 depicting pairing of a first public key and a second public key to permit secure digital currency transfer.

FIG. 5 is a flow diagram for a method of carrying out digital currency transfer using the digital currency transfer security device and system of FIGS. 3 and 4.

### DETAILED DESCRIPTION

The disclosed digital currency transfer security devices and systems will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various digital currency transfer security devices and systems are provided. Related features in the examples may be identical, similar, or dissimilar in different examples. For the sake of brevity; related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

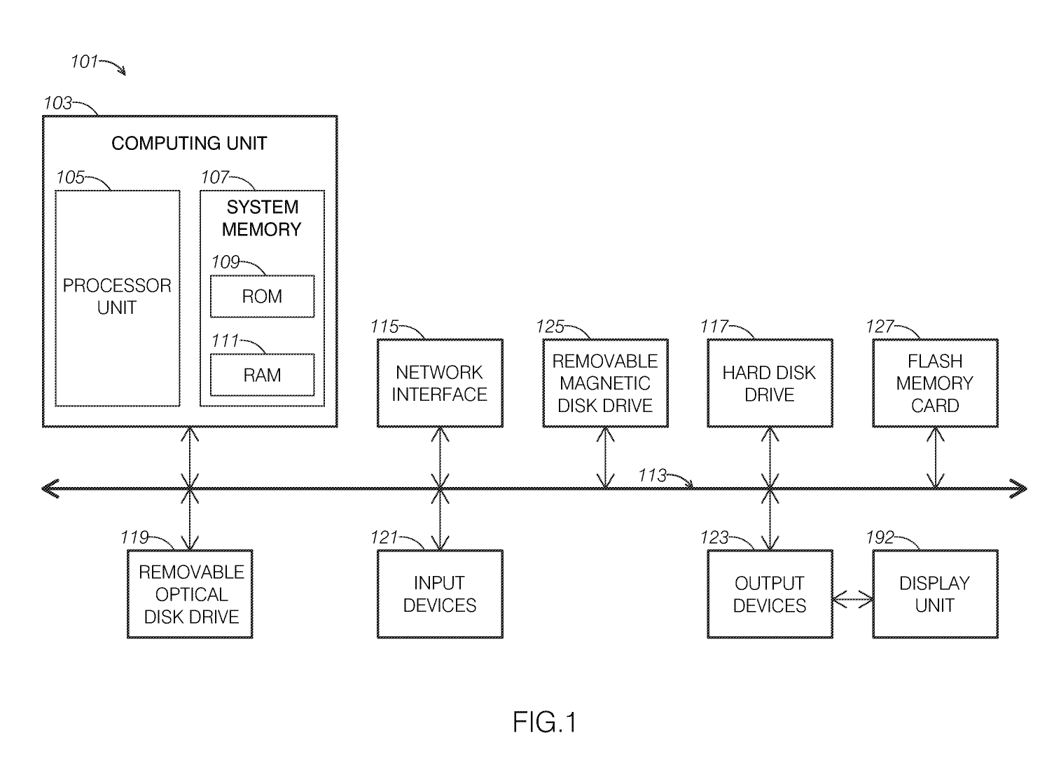

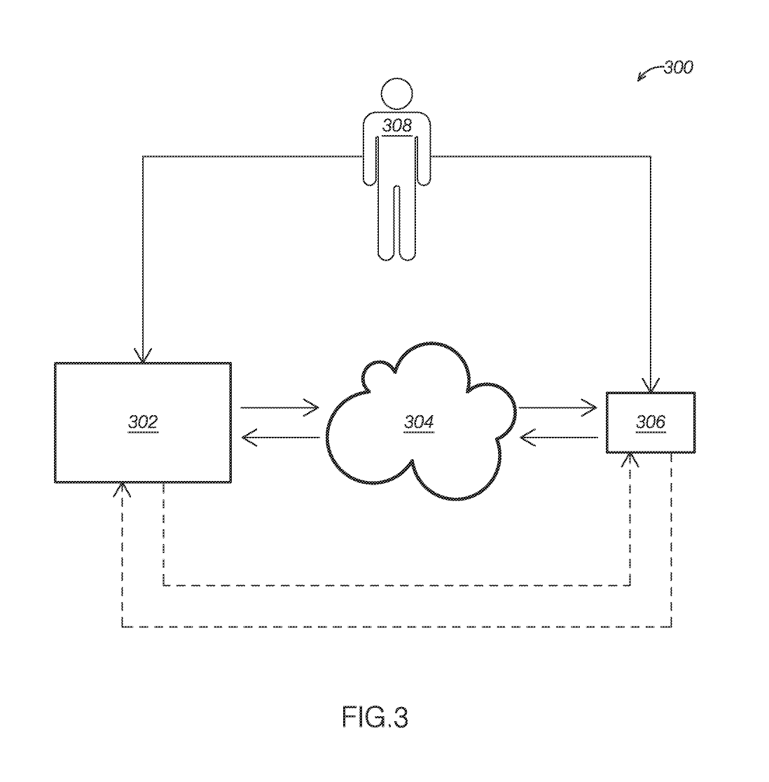

With reference to FIGS. 1-5, a first example of a digital currency transfer security system, digital currency transfer security system 300, will now be described. Digital currency transfer security system 300 includes a primary device 302 (i.e., a first device) and a digital currency transfer security peripheral device 306 (i.e., a second device). As shown in FIG. 3, primary device 302 and peripheral security device 306 communicate via a network 304. Also shown in FIG. 3, additionally or alternatively, primary device 302 and peripheral device 306 can be in direct communication.

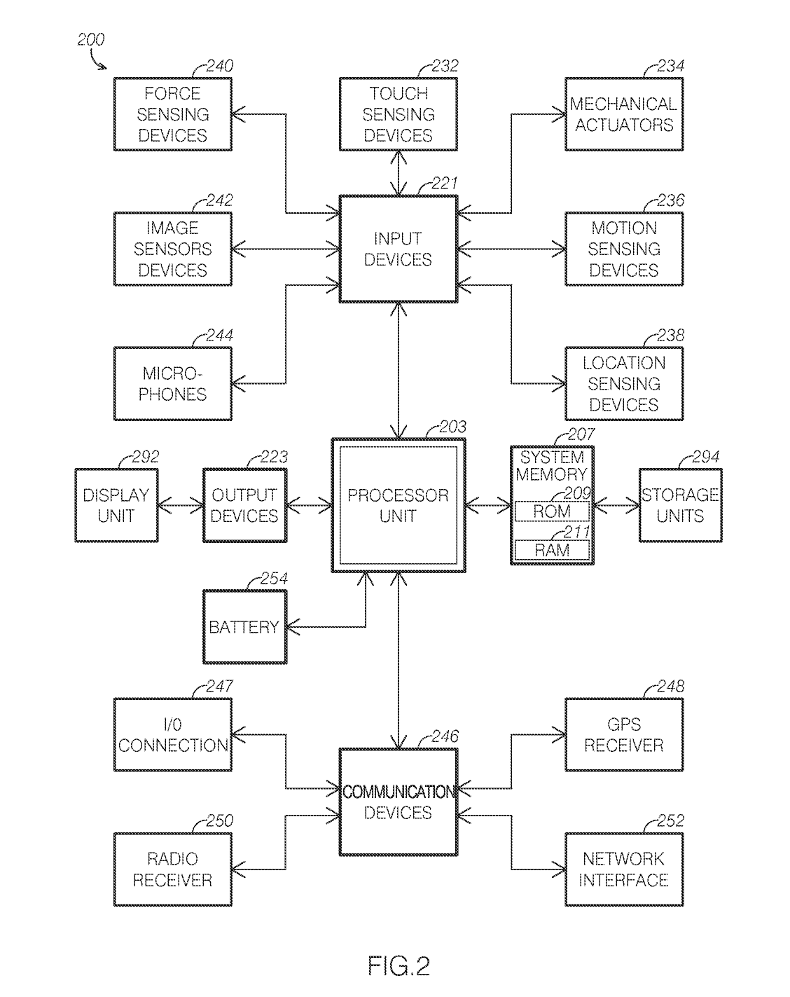

Primary device 302 and peripheral security device 306 can be either of a computer 101 (shown in FIG. 1) or a mobile device 200 (shown in FIG. 2). Generally, primary device 302 is a personal computer (e.g., computer 101) and/or a personal cellular phone (e.g., mobile device 200) and peripheral security device 306 is a personal mobile digital currency transfer security device (e.g., mobile device 200). Both primary device 302 and peripheral security device 306 are operable by and under control of an end user 308.

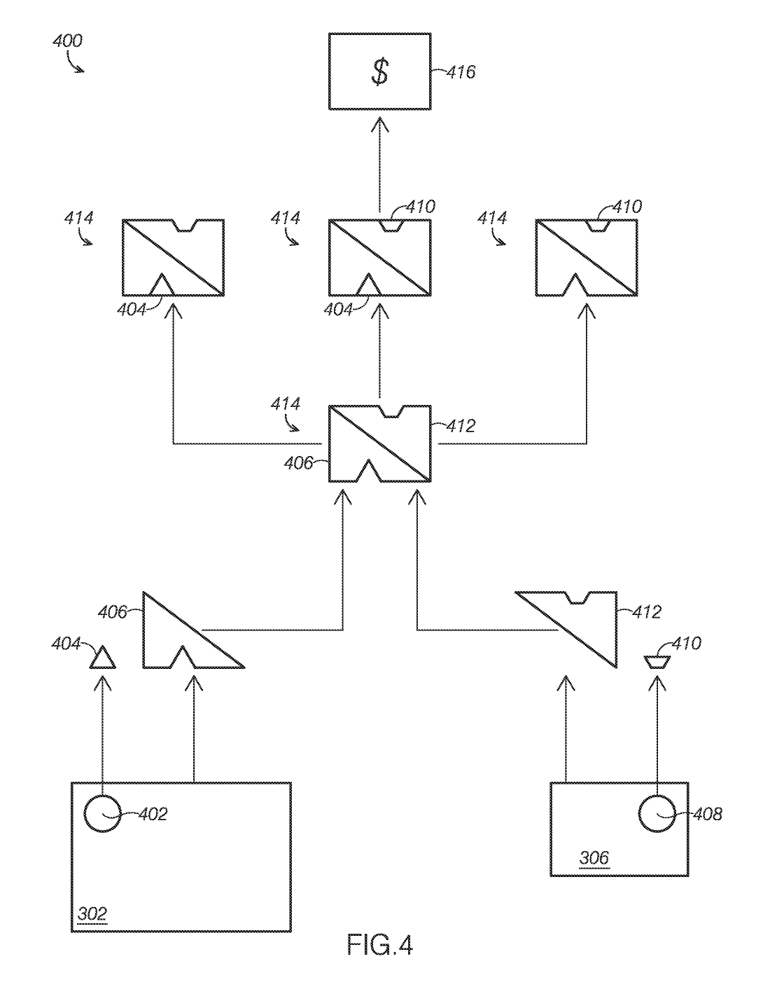

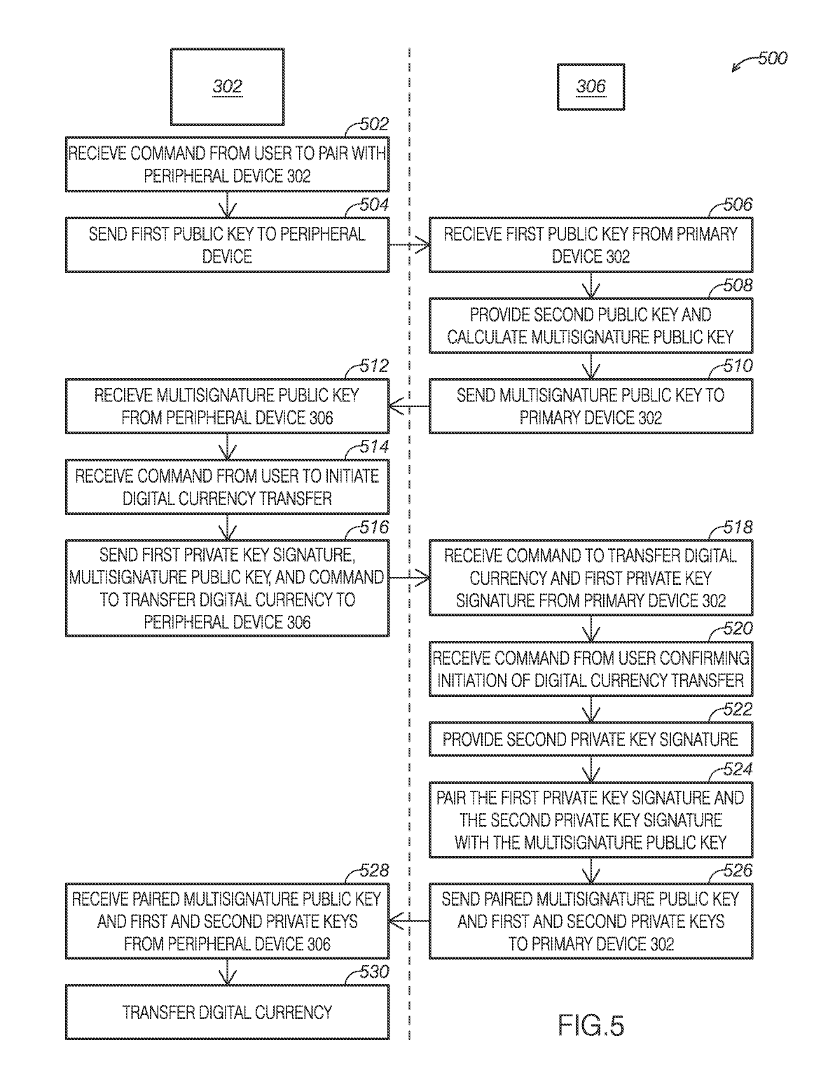

FIGS. 4 and 5 show example methods (i.e., digital currency transfer methods 400 and 500) for carrying out digital currency transfer using primary device 302 and peripheral security device 306. In general, a multisignature public key 414 is calculated and/or generated from a first public key 406 provided by primary device 302 and a second publice key 412 provided by peripheral security device 306. Multisignature public key 414 can be accessed for transfer of digital currency by providing a first private key signature 404 from primary device 302 and a second private key signature 410 from peripheral security device 306.

Digital currency transfer security system 300 functions to provide a security system for storage of digital currency by calculating/generating the multisignature public key and storing digital currency in the multisignature public key. Additionally or alternatively, digital currency transfer security system 300 can be used to protect unauthorized transfer of digital currency by requiring two private key signatures from two different devices under control of the end user (e.g., the primary device and the peripheral security device) in order to transfer digital currency.

Various disclosed examples for the digital security transfer system may be implemented using electronic circuitry configured to perform one or more functions. For example, with some embodiments of the invention, the disclosed examples may be implemented using one or more application-specific integrated circuits (ASICs). More typically, however, components of various examples of the invention will be implemented using a programmable computing device executing firmware or software instructions, or by some combination of purpose-specific electronic circuitry and firmware or software instructions executing on a programmable computing device.

Accordingly, FIG. 1 shows one illustrative example of a computer, computer 101, which can be used to implement various embodiments of the invention. Computer 101 may be incorporated within a variety of consumer electronic devices, such as personal media players, cellular phones, smart phones, personal data assistants, global positioning system devices, and the like.

As seen in FIG. 1, computer 101 has a computing unit 103. Computing unit 103 typically includes a processing unit 105 and a system memory 107. Processing unit 105 may be any type of processing device for executing software instructions, but will conventionally be a microprocessor device. System memory 107 may include both a read-only memory (ROM) 109 and a random access memory (RAM) 111. As will be appreciated by those of ordinary skill in the art, both read-only memory (ROM) 109 and random access memory (RAM) 111 may store software instructions to be executed by processing unit 105.

Processing unit 105 and system memory 107 are connected, either directly or indirectly, through a bus 113 or alternate communication structure to one or more peripheral devices. For example, processing unit 105 or system memory 107 may be directly or indirectly connected to additional memory storage, such as a hard disk drive 117, a removable optical disk drive 119, a removable magnetic disk drive 125, and a flash memory card 127. Processing unit 105 and system memory 107 also may be directly or indirectly connected to one or more input devices 121 and one or more output devices 123. Input devices 121 may include, for example, a keyboard, touch screen, a remote control pad, a pointing device (such as a mouse, touchpad, stylus, trackball, or joystick), a scanner, a camera or a microphone. Output devices 123 may include, for example, a monitor display, an integrated display, television, printer, stereo, or speakers.

Still further, computing unit 103 will be directly or indirectly connected to one or more network interfaces 115 for communicating with a network. This type of network interface 115 is also sometimes referred to as a network adapter or network interface card (NIC). Network interface 115 translates data and control signals from computing unit 103 into network messages according to one or more communication protocols, such as the Transmission Control Protocol (TCP), the Internet Protocol (IP), and the User Datagram Protocol (UDP). These protocols are well known in the art, and thus will not be discussed here in more detail. An interface 115 may employ any suitable connection agent for connecting to a network, including, for example, a wireless transceiver, a power line adapter, a modem, or an Ethernet connection.

It should be appreciated that, in addition to the input, output and storage peripheral devices specifically listed above, the computing device may be connected to a variety of other peripheral devices, including some that may perform input, output and storage functions, or some combination thereof. For example, the computer 101 may be connected to a digital music player, such as an IPOD® brand digital music player or iOS or Android based smartphone. As known in the art, this type of digital music player can serve as both an output device for a computer (e.g., outputting music from a sound file or pictures from an image file) and a storage device.

In addition to a digital music player, computer 101 may be connected to or otherwise include one or more other peripheral devices, such as a telephone. The telephone may be, for example, a wireless “smart phone,” such as those featuring the Android or iOS operating systems. As known in the art, this type of telephone communicates through a wireless network using radio frequency transmissions. In addition to simple communication functionality, a “smart phone” may also provide a user with one or more data management functions, such as sending, receiving and viewing electronic messages (e.g., electronic mail messages, SMS text messages, etc.), recording or playing back sound files, recording or playing back image files (e.g., still picture or moving video image files), viewing and editing files with text (e.g., Microsoft Word or Excel files, or Adobe Acrobat files), etc. Because of the data management capability of this type of telephone, a user may connect the telephone with computer 101 so that their data maintained may be synchronized.

Of course, still other peripheral devices may be included with or otherwise connected to a computer 101 of the type illustrated in FIG. 1, as is well known in the art. In some cases, a peripheral device may be permanently or semi-permanently connected to computing unit 103. For example, with many computers, computing unit 103, hard disk drive 117, removable optical disk drive 119 and a display are semi-permanently encased in a single housing.

Still other peripheral devices may be removably connected to computer 101, however. Computer 101 may include, for example, one or more communication ports through which a peripheral device can be connected to computing unit 103 (either directly or indirectly through bus 113). These communication ports may thus include a parallel bus port or a serial bus port, such as a serial bus port using the Universal Serial Bus (USB) standard or the IEEE 1394 High Speed Serial Bus standard (e.g., a Firewire port). Alternately or additionally, computer 101 may include a wireless data “port,” such as a Bluetooth® interface, a Wi-Fi interface, an infrared data port, or the like.

It should be appreciated that a computing device employed according to the various examples of the invention may include more components than computer 101 illustrated in FIG. 1, fewer components than computer 101, or a different combination of components than computer 101. Some implementations of the invention, for example, may employ one or more computing devices that are intended to have a very specific functionality, such as a digital music player or server computer. These computing devices may thus omit unnecessary peripherals, such as the network interface 115, removable optical disk drive 119, printers, scanners, external hard drives, etc. Some implementations of the invention may alternately or additionally employ computing devices that are intended to be capable of a wide variety of functions, such as a desktop or laptop personal computer. These computing devices may have any combination of peripheral devices or additional components as desired.

In many examples, computers may define mobile electronic devices, such as smartphones, tablet computers, or portable music players, often operating the iOS, Symbian, Windows-based (including Windows Mobile and Windows 8), or Android operating systems.

With reference to FIG. 2, an exemplary mobile device, mobile device 200, may include a processor unit 203 (e.g., CPU) configured to execute instructions and to carry out operations associated with the mobile device. For example, using instructions retrieved from memory, the controller may control the reception and manipulation of input and output data between components of the mobile device. The controller can be implemented on a single chip, multiple chips or multiple electrical components. For example, various architectures can be used for the controller, including dedicated or embedded processor, single purpose processor, controller, ASIC, etc. By way of example, the controller may include microprocessors, DSP, A/D converters, D/A converters, compression, decompression, etc.

In most cases, the controller together with an operating system operates to execute computer code and produce and use data. The operating system may correspond to well known operating systems such as iOS, Symbian, Windows-based (including Windows Mobile and Windows 8), or Android operating systems, or alternatively to special purpose operating system, such as those used for limited purpose appliance-type devices. The operating system, other computer code and data may reside within a system memory 207 that is operatively coupled to the controller. System memory 207 generally provides a place to store computer code and data that are used by the mobile device. By way of example, system memory 207 may include read-only memory (ROM) 209, random-access memory (RAM) 211, etc. Further, system memory 207 may retrieve data from storage units 294, which may include a hard disk drive, flash memory, etc. In conjunction with system memory 207, storage units 294 may include a removable storage device such as an optical disc player that receives and plays DVDs, or card slots for receiving mediums such as memory cards (or memory sticks).

Mobile device 200 also includes input devices 221 that are operatively coupled to processor unit 203. Input devices 221 are configured to transfer data from the outside world into mobile device 200. As shown, input devices 221 may correspond to both data entry mechanisms and data capture mechanisms. In particular, input devices 221 may include the following: touch sensing devices 232 such as touch screens, touch pads and touch sensing surfaces; mechanical actuators 234 such as button or wheels or hold switches; motion sensing devices 236 such as accelerometers; location detecting devices 238 such as global positioning satellite receivers, WiFi based location detection functionality, or cellular radio based location detection functionality; force sensing devices such as force sensitive displays and housings; image sensors; and microphones. Input devices 221 may also include a clickable display actuator.

Mobile device 200 also includes various output devices 223 that are operatively coupled to processor unit 203. Output devices 223 are configured to transfer data from mobile device 200 to the outside world. Output devices 223 may include a display unit 292 such as an LCD, speakers or jacks, audio/tactile feedback devices, light indicators, and the like.

Mobile device 200 also includes various communication devices 246 that are operatively coupled to the controller. Communication devices 246 may, for example, include both an I/O connection 247 that may be wired or wirelessly connected to selected devices such as through IR, USB, or Firewire protocols, a global positioning satellite receiver 248, and a radio receiver 250 which may be configured to communicate over wireless phone and data connections. Communication devices 246 may also include a network interface 252 configured to communicate with a computer network through various means which may include wireless connectivity to a local wireless network, a wireless data connection to a cellular data network, a wired connection to a local or wide area computer network, or other suitable means for transmitting data over a computer network.

Mobile device 200 also includes a battery 254 and possibly a charging system. Battery 254 may be charged through a transformer and power cord or through a host device or through a docking station. In the cases of the docking station, the charging may be transmitted through electrical ports or possibly through an inductance charging means that does not require a physical electrical connection to be made.

The various aspects, features, embodiments or implementations of the invention described above can be used alone or in various combinations. The methods of this invention can be implemented by software, hardware or a combination of hardware and software. The invention can also be embodied as computer readable code on a computer readable medium. The computer readable medium is any data storage device that can store data which can thereafter be read by a computer system, including both transfer and non-transfer devices as defined above. Examples of the computer readable medium include read-only memory, random access memory, CD-ROMs, flash memory cards, DVDs, magnetic tape, optical data storage devices, and carrier waves. The computer readable medium can also be distributed over network-coupled computer systems so that the computer readable code is stored and executed in a distributed fashion.

As stated above and shown in FIG. 3, digital currency transfer security system 300 includes primary device 302 (i.e., a first device) and digital currency transfer security peripheral device 306 (i.e., a second device). Primary device 302 and peripheral security device 306 communicate via a network 304 and/or primary device 302 and peripheral device 306 can be in direct communication. For example, the primary device and the peripheral security device can communicate via one or more of Bluetooth, Wifi, and a cellular network.

Primary device 302 and peripheral security device 306 can be either of computer 101 (shown in FIG. 1) or mobile device 200 (shown in FIG. 2). Generally, primary device 302 is a personal computer (e.g., computer 101) of an end user 308 and peripheral security device 306 is a personal mobile digital currency transfer security device (e.g., mobile device 200) of end user 308. Thus, both the primary device and the peripheral security device are operable by and under control of the end user.

Primary device 302 is configured to store and/or transfer digital currency (e.g., various cryptocurrencies such as Bitcoin currency, Ven currency, etc.) in one or more public keys. The one or more public keys may be stored in one or more collections or sets of public keys (e.g., in one more digital wallets). In some examples, transactions of digital currency transfer are recorded into a public ledger in exchange for transaction fees. Further, in some examples, digital currency can be transferred by broadcasting digitally signed messages to a network requesting an update to the public transaction database. Furthermore, the digital currency can then be exchanged for products, services, or other currencies. Further still, in these examples, digital currency can use public-key cryptography for broadcasting of digitally signed messages, in which a pair of public and private cryptographic keys is generated.

As stated above, primary device 302 is configured to store one or more public keys. Further, primary device 302 is configured to store one or more private keys paired with the one or more public keys. The private key specifically paired to a public key acts as a safe guard because a private key signature generated by the private key is required to access and/or transfer digital currency stored in the corresponding public key (i.e., the public key paired to the private key). However, if an unauthorized user was to gain unauthorized access to primary device 302 (e.g., physical access, remote access, etc.), the paired private keys could be accessed in order to carry out unauthorized transfer of digital currency (i.e., steal digital currency).

In order to further safe guard against unauthorized digital currency transfer, digital currency transfer security system 300 includes digital currency transfer peripheral security device 306. Peripheral security device 306 is configured to provide an additional security measure during digital currency transfer from primary device 302. For example, when primary device 302 receives a command from end user 308 for digital currency transfer, a second command can be required to be input by the end user into peripheral security device 306 to confirm the digital currency transfer. In this example, transfer of digital currency may only occur with a command from the end user into two separate devices (e.g., primary device 302 and peripheral security device 306). Thus, even if an unauthorized user gains access to the primary device, unauthorized transfer of digital currency may be prevented. In some examples, the peripheral security device is also capable of storing and transferring digital currency.

FIG. 4 shows a schematic diagram for a generalized example method for carrying out digital currency transfer via digital currency transfer system 300, digital currency transfer method 400. In method 400, primary device 302 is configured to store a first private key 402 and provide a first private key signature 404 and a first public key 406. Similarly, peripheral security device is configured to store a second private key 408 and provide a second private key signature 410 and a second public key 412.

As schematically depicted in FIG. 4, first private key signature 404 is specifically configured to pair to first public key 406 for accessing first public key 406. Similarly, second private key signature 410 is specifically configured to pair with second public key 412 for accessing second public key 412. Also depicted in FIG. 4, first public key 406 is configured to be combined with second public key 412 to calculate and/or generate a multisignature public key 414.

Multisignature public key 414 is configured to and capable of storing and/or transferring digital currency. Further, multisignature public key 414 can be paired with first private key signature 404 and/or second private key signature 410. As shown in FIG. 4, however, a digital currency transfer event 416 (i.e., access to the multisignature public key) results only from pairing of both first private key signature 404 and second private key signature 410 with multisignature public key 414.

Thus, in example method 400, digital currency is stored in a multisignature public key (i.e., multisignature public key 414) that is calculated from a public key (i.e., first public key 406) provided by the end user's primary device (i.e., primary device 302) and an additional public key (i.e., second public key 412) provided by the end user's digital currency transfer security peripheral device (i.e., peripheral security device 306). Further, in this example, a private key signature from the end user's primary device (i.e., first private key signature 404) and a private key signature from the end user's peripheral security device (i.e., second private key signature (410) must both be provided in order to carry out digital currency transfer (i.e., digital currency transfer event 416) and be accepted on the digital currency network.

As stated above, each of the primary device and the peripheral security device are operated by and under control of the end user. Therefore, even if an unauthorized user were to gain unauthorized access to the end user's primary device, which is generally the target for digital currency and data theft, the unauthorized user would not be able to carry out digital currency transfer. Further, even if an unauthorized user were to gain unauthorized access to the end user's peripheral security device, the unauthorized user would not be able to carry out digital currency transfer.

One specific example method for carrying out digital currency transfer via digital currency transfer system 300, digital currency transfer method 500, is shown in the method flow chart diagram of FIG. 5. Digital currency transfer method 500 includes steps carried out by both primary device 302 and peripheral security device 306. Steps carried out by primary device 302 are show in the left-hand column, while steps carried out by peripheral device 306 are shown in the right-hand column.

Method 500 begins at step 502 with primary device 302 receiving a command from the end user to pair with peripheral security device 306. In response to the command for pairing, at step 504, primary device 302 sends a first public key (e.g., public key 406) to peripheral security device 306. At 506, peripheral security device 306 receives the first public key from primary device 302. In some example methods, the peripheral security device does not store the first public key and stores instead a hashed index corresponding to the first public key.

Peripheral security device 306 then provides a second public key (e.g., second public key 412 and calculates and/or generates a multisignature public key (e.g., multisignature public key 414) from a combination of the first public key and the second public key at step 508. Peripheral security device 306 sends the multisignature public key to primary device 302 at step 510. In some alternate example methods, the peripheral security device sends the second public key and the multisignature public key to the primary device. In other alternate example methods, the peripheral securing device sends the second public key to the primary device, and the primary device calculates and/or generates the multisignture public key.

At step 512, primary device 302 receives the multisignature public key from peripheral device 306. After step 512, the primary device is then in a paired status with the peripheral security device. In the paired status, digital currency is stored in the multisignature public key. Storage of the digital currency in the multisignature public key may be maintained until primary device 302 receives a command from the end user to initiate digital currency transfer, such as in step 514. Alternatively, digital currency can be stored in the multisignature key indefinitely.

After receiving the command to initiate digital currency transfer, primary device 302 sends the command and a first private key signature (e.g., first private key signature 404) to peripheral security device 306 at step 516. In some examples, the primary device selects multiple multisignature keys that collectively store an appropriate amount of digital currency to fulfill the requested transaction amount in the command from the end user.

Peripheral security device 306 receives the command to transfer digital currency and the first private key signature for primary device 302 at step 518, and then receives a confirmation command from the end user confirming the initiation of digital currency transfer at step 520. In one example, the peripheral security device may query the end user if they would like to confirm a digital currency transfer request. In another example, the end user may have to select a specific requested digital currency transfer request for a list of requests. Alternatively, if the peripheral security device does not receive the confirmation command, the digital currency transfer event will not occur.

At step 522, peripheral security device 306 then provides a second private key signature (e.g., private key signature 410). Peripheral device 306 then pairs the first private key signature and the second private key signature with the multisignature public key and sends the paired multisignature public key and first and second private keys to primary device 302 at steps 524 and 526, respectively. In some alternate examples, the primary device pairs the first private key signature to the multisignature public key device prior to sending the multisignature public key to the peripheral security device. In these examples, the peripheral security device checks that the first private key signature is correctly paired to the multisignature public key and then pairs the second private key signature to the partially signed multisignature public key prior to returning the multisignature public key to the primary device.

Finally, primary device 302 receives the paired multisignature public key and first and second private keys from peripheral device 306 and performs digital currency transfer at steps 526 and 528, respectively. After completion of method 500, the digital currency transfer event (e.g., digital currency transfer event 416) is announced on the digital currency network. The network, seeing that the transaction message was signed correctly with both of the first and second private key signatures then transfers the digital currency and the transfer is logged in the public transaction database. In some examples, the transaction generates two outputs, one being an output of the transaction amount and the second being an output of any remaining balance (i.e., generating a new remaining balance multisignature public key). In examples where there is a remaining balance output, the peripheral security device can independently verify the new remaining balance multisignature public key.

It will be appreciated that the digital currency transfer system may include additional components. For example, a digital currency transfer system can include two or more peripheral security devices (e.g., 2, 3, 4, 5 . . . ) as desired. In this example, a multisignature public address can be generated/calculated from two or more public keys each provided by one of the peripheral security devices. Thus, access and/or transfer of digital currency stored in the multisignature public address may require a private key signature from each of the peripheral security devices, thereby increasing a degree of security. In the above example, generally the same method described in method 500 (shown in FIG. 5) could be used with the digital currency transfer system including two or more peripheral security devices.

Moreover, it will be appreciated that each of the primary device and the peripheral security device can include a computer with a processor and a non-transitory computer-readable storage medium for carrying out the method described above.

More specifically, the primary device can include a first computer with a first processor and a first non-transitory computer-readable storage medium, first non-transitory computer-readable storage medium having a first set of computer-readable instructions for:

storing digital currency,
receiving a command from the end user to send the first public key to the peripheral device, providing a first public key,
sending the first public key to the peripheral device,
   receiving a command from the end user to initiate a digital currency transfer, and
   sending the command to initiate the digital currency transfer, the first private key signature, and the multisignature public key to the digital currency transfer peripheral security device.

Further, the peripheral security device can include a second computer with a second processor and a second non-transitory computer-readable storage medium, second non-transitory computer-readable storage medium having a second set of computer-readable instructions for:
receiving the first public key from the primary device,
providing the second public key,
generating the multisignature public key from the first public key and the second public key,
sending the multisignature public key to the primary device,
receiving a command to initiate a digital currency transfer, the first private key signature, and the multisignature public key from the primary device,
receiving a command from the end user to confirm the digital currency transfer,
pairing the multisignature public key with the first private key signature and the second private key signature, and
sending the multisigntaure public key paired with the first private key signature and the second private key signature to the primary device to allow digital currency transfer.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A digital currency transfer security system operable by an end user, comprising:
a digital network;
a first device configured to store and transfer digital currency, the first device being connected to the digital network, the first device having a first computer with a first processor, a first non-transitory computer-readable storage medium, the first non-transitory computer readable storage medium having a first set of computer-readable instructions for:
providing a first public key, and
providing a first private key signature, the first public key being accessible via the first private key signature; and
a second device configured to provide a security measure during transfer of digital currency from the first device, the second device being connected to the digital network, the second device having a second computer with a second processor, a second non-transitory computer-readable storage medium, the second non-transitory computer-readable storage medium having a second set of computer-readable instructions for:
providing a second public key, and
providing a second private key signature, the second public key being accessible via the second private key signature;
wherein providing the first public key from the first device and the second public key from the second device generates a multisignature public key capable of storing and transferring digital currency, the multisignature public key being accessible for transfer of digital currency via the first private key signature and the second private key signature.

2. The digital currency transfer security system of claim 1, wherein the first public key and the second public key are each capable of storing and transferring digital currency.

3. The digital currency transfer security system of claim 1, wherein the first device and the second device are each operable by and under control of the end user.

4. The digital currency transfer security system of claim 1, wherein the first device is a personal computer operable by the end user.

5. The digital currency transfer security system of claim 1, wherein the first device is a personal mobile device operable by the end user.

6. The digital currency transfer security system of claim 1, wherein the second device is a personal currency transfer security peripheral device operable by the end user.

7. The digital currency transfer security system of claim 1, wherein the first set of computer-readable instructions further comprise instructions for storing digital currency and receiving a command from the end user to send the first public key to the second device.

8. The digital currency transfer security system of claim 6, wherein the second set of computer-readable instructions further comprise instructions for receiving the first public key from the first device, generating the multisignature public key, and sending the multisignature public key to the first device.

9. The digital currency transfer security system of claim 7, wherein the first set of computer-readable instructions further comprise instructions for receiving a command from the end user to initiate a digital currency transfer and sending the command to initiate the digital currency transfer, the first private key signature, and the multisignature public key to the second device.

10. The digital currency transfer security system of claim 8, wherein the second set of computer-readable instructions further comprise instructions for receiving the command to initiate the digital currency transfer, the first private key signature, and the multisignature public key from the first device, receiving a command from the end user to confirm the digital currency transfer, pairing the first private key signature and the second private key signature with the multisignature public key, and sending the multisignature public key paired with the first private key signature and the second private key signature to the first device to allow digital currency transfer.

11. A digital currency transfer peripheral security device configured to provide a security measure during digital currency storage and digital currency transfer from a primary device, the digital currency transfer peripheral security device comprising:
a first computer with a first processor, the first computer connected to a digital network; and
a first non-transitory computer-readable storage medium having a first set of computer-readable instructions for:
providing a second public key for pairing with a first public key provided by the primary device to generate a multisignature public key,
providing a secondary private key signature for pairing with a first private key signature provided by the primary device and the multisignature public key, the first public key being accessible via the first private key signature, the second public key being accessible via the secondary private key signature, and the multisignature public key being accessible via the first private key signature and the second private key signature,
wherein the multisignature public key is capable of storing and transferring digital currency.

12. The digital currency transfer peripheral security device of claim 11, wherein each of the peripheral device and the primary device are operable by and under control of an end user.

13. The digital currency transfer peripheral security device of claim 11, wherein the first set of computer-readable instructions further comprise instructions for:
receiving the first public key from the primary device,
generating the multisignature public key, and
sending the multisignature public key to the primary device.

14. The digital currency transfer peripheral security device of claim 13, wherein the first set of computer-readable instructions further comprise instructions for:
receiving a command to initiate a digital currency transfer, the first private key signature, and the multisignature public key from the primary device,
receiving a command from the end user to confirm the digital currency transfer,
pairing the multisignature public key with the first private key signature and the second private key signature, and
sending the multisignature publick key paired first private key signature and the second private key signature to the primary device to allow digital currency transfer.

15. The digital currency transfer peripheral security device of claim 11, wherein the primary device is one of a personal computer operable by an end user and a personal mobile device operable by the end user.

16. The digital currency transfer peripheral security device of claim 11, wherein the primary device comprises a second computer with a second processor and a second non-transitory computer-readable storage medium having a second set of computer-readable instructions, the second set of computer-readable instructions comprising instructions for:
providing the first public key, and
providing the first private key signature.

17. The digital currency transfer peripheral security device of claim 16, wherein the second set of computer-readable instructions further comprise instructions for:
storing digital currency, and
receiving a command from the end user to send the first public key to the peripheral device.

18. The digital currency transfer peripheral security device of claim 17, wherein the second set of computer-readable instructions further comprise instructions for:
receiving a command from the end user to initiate a digital currency transfer, and
sending the command to initiate the digital currency transfer and the first private key signature, and the multisignature public key to the peripheral device.

19. A digital currency transfer security system operable by an end user, comprising:
a digital network;
a primary device configured to provide a first public key and a first private key signature, the first public key being accessible via the first private key signature, the primary device being connected to the digital network, the primary device having a first computer with a first processor and a first non-transitory computer-readable storage medium, first non-transitory computer-readable storage medium having a first set of computer-readable instructions; and
a digital currency transfer peripheral security device configured to provide a second public key and a second private key signature, the second public key being accessible via the second private key signature, the digital currency transfer peripheral security device being connected to the digital network, the digital currency transfer peripheral security device having a second computer with a second processor and a second non-transitory computer-readable storage medium, the second non-transitory computer readable storage medium having a second set of computer-readable instructions for:
receiving the first public key from the primary device,
providing the second public key,
generating the multisignature public key from the first public key and the second public key,
sending the multisignature public key to the primary device,
receiving a command to initiate a digital currency transfer, the first private key signature, and the multisignature public key from the primary device,
receiving a command from the end user to confirm the digital currency transfer,
pairing the multisignature public key with the first private key signature and the second private key signature, and
sending the multisigntaure public key paired with the first private key signature and the second private key signature to the primary device to allow digital currency transfer,
wherein the mulitisignature public key is capable of storing and transferring digital currency, the multisignature public key being accessible for transfer of digital currency via pairing with the first private key signature and the second private key signature, and
wherein the primary device and the digital currency transfer peripheral security device are each under control of and operable by an end user.

20. The digital currency transfer security system of claim 18, wherein has the first set of computer-readable instructions comprise instructions for:
storing digital currency,
receiving a command from the end user to send the first public key to the peripheral device,
providing a first public key,
sending the first public key to the peripheral device,
receiving a command from the end user to initiate a digital currency transfer, and
sending the command to initiate the digital currency transfer, the first private key signature, and the multisignature public key to the digital currency transfer peripheral security device.
